(19) United States
(12) Patent Application Publication
(10) Pub. No.: US 2016/0246205 A1
(43) Pub. Date: Aug. 25, 2016

(54) IMAGE FORMING APPARATUS

(71) Applicant: Oki Data Corporation, Tokyo (JP)

(72) Inventor: Yuji HIRANO, Tokyo (JP)

(73) Assignee: Oki Data Corporation, Tokyo (JP)

(21) Appl. No.: 14/955,917

(22) Filed: Dec. 1, 2015

(30) Foreign Application Priority Data
Feb. 20, 2015 (JP) 2015-031616

(51) Int. Cl. G03G 15/01

(52) U.S. Cl. CPC G03G 15/0121

(57) ABSTRACT

An image forming apparatus prints a special color image on the top of and/or the bottom of primary colors and black images. At least one first print engine forms a first image of a first developer material selected from a group consisting of the primary colors, and black developer materials of a color model. The first print engine prints the first image on a medium. A second print engine is disposed upstream of the at least one first print engine, and forms a second image of a second developer material other than the group. A third print engine is disposed downstream of the at least one first print engine, and forms a third image of a third developer material other than the group. The first, second, and third print engines operate so that the first image is sandwiched between the second and third images.

### BACKGROUND OF THE INVENTION

1. Field of the Invention

The present invention generally relates to an image forming apparatus, and more particularly to an image forming apparatus that forms images using not only color developer materials of YMCK model but also a special color developer material, for example, white.

2. Description of the Related Art

Conventionally, a computer sends image data to a printer, which in turn prints the image data. The printer includes a plurality of drum cartridges for printing images of different colors, e.g., cyan, magenta, yellow (primary colors), and black. Some printers may include a special drum cartridge configured to print images using a special color developer material.

The special drum cartridge may be a drum cartridge for printing a white toner image, and is located either upstream of the drum cartridges for printing cyan, magenta, yellow, and black toner images or downstream of them with respect to a direction in which print paper as a print medium is transported. The white toner is transferred directly onto the print paper or onto the color images.

Japanese Patent Publication No. 2014-95784 discloses a printer in which a special drum cartridge is located only at a downstream end. The white toner image is first transferred onto the print paper on which the image data is to be printed, and then the print paper is again fed back to the upstream end of the plurality of drum cartridges for transferring the cyan, magenta, yellow, and black toner layers onto the white toner layer.

However, feeding the print paper in two passes through the drum cartridges may cause misalignment between the toner images printed in the first pass and the toner images printed in the second pass. This results in poor print quality.

### SUMMARY OF THE INVENTION

The present invention was made in view of the aforementioned drawbacks.

An object of the invention is to provide an image forming apparatus capable of forming high quality images.

An image forming apparatus prints a special color image on the top of primary color and black images and/or on the bottom of the primary color and black images. At least one first print engine forms a first image of a first developer material selected from a group consisting of primary colors and black developer materials of a color model. The first print engine prints the first image on a medium. A second print engine is disposed upstream of the at least one first print engine, and forms a second image of a second developer material other than the group. A third print engine is disposed downstream of the at least one first print engine, and forms a third image of a third developer material other than the group. The first, second, and third print engines operate so that the first image is sandwiched between the second and third images.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given byway of illustration only, and wherein:

FIG. 1 illustrates a color electrophotographic printer of intermediate transfer type according to a first embodiment;

FIG. 2 illustrates a system controller that centrally controls the color printer according to the first embodiment;

FIG. 3 illustrates a special color printing settings screen according to the first embodiment;

FIGS. 4 and 5 illustrate the printing procedure of the color printer according to the first embodiment;

FIG. 6 illustrates a color electrophotographic printer according to a second embodiment;

FIG. 7 illustrates a system controller that centrally controls the color printer according to the second embodiment;

FIG. 8 illustrates a special color printing settings screen DIP1 according to the second embodiment; and

FIGS. 9 and 10 illustrate the printing procedure of the color printer according to the second embodiment.

### DETAILED DESCRIPTION OF THE INVENTION

By way of preferred embodiments, the present invention will be described in detail with reference to the accompanying drawings. In the specification, the term color image data covers image data for printing color images of yellow (Y), magenta (M), cyan (C), and black (K). The term special color image data covers image data for printing an image of a special color. In the present invention, the special color is typically white (W) or transparent.

### First Embodiment

### General Construction of Color Printer

In the specification, a color image refers to an image of one of primary colors of a color model (i.e., cyan (C), magenta (M), yellow (Y) or red (R), green (G), and blue (B)) and black (K). A special color image refers to an image of other than the primary colors, and is, for example, a white or transparent image.

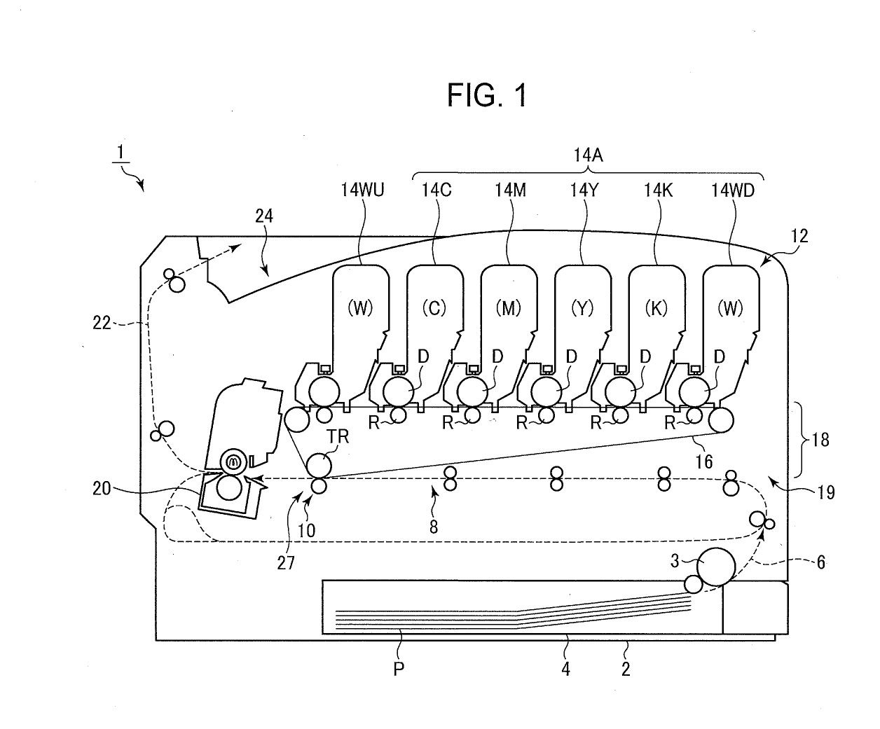

FIG. 1 illustrates a color electrophotographic printer 1 of intermediate transfer type or indirect transfer type according to a first embodiment. The printer 1 prints a color image on, for example, sufficiently flexible A4 size or A3 size print paper P. The color printer 1 includes a generally box-shaped casing 2.

A paper tray 4 is disposed at a lower portion of the casing 2, and accommodates a vertical stack of the print paper P. A pick-up roller 3 is disposed in the vicinity of the exit of the paper tray 4, and feeds the print paper P into a feeding path 6 that rises to guide the print paper 4 to a middle path 8. A pair of rollers is disposed in the feeding path 6, and is driven in rotation by a motor (not shown) to transport the print paper P sandwiched therebetween upwardly through the feeding path 6 to the middle path 8. The middle path 8 in turn guides the print paper P toward the transfer section 10.

The middle path 8 includes a plurality of pairs of rollers, which guides the print paper P to the transfer section 10. The middle path 8 extends in a direction parallel to a direction in which drum cartridges 14WU, 14K, 14Y, 14M, 14C, and 14WD are aligned. The transfer section 10 is located near the drum cartridge 14WD.

The drum cartridges 14WU, 14K, 14Y, 14M, 14C, and 14WD constitute an image forming section 12. The drum cartridges 14WU, 14K, 14Y, 14M, 14C, and 14WD are detachably attached to the printer body, and form white (W), black (K), yellow (Y), magenta (M), cyan (C) and white (W) images in the CMYK model, respectively. The drum cartridges 14WU is a white drum cartridge disposed at an upstream end, and the drum cartridges 14WD is a white drum cartridge disposed at a downstream end.

A belt driving mechanism 18 is disposed between the image forming section 12 and the middle path 8, and drives an intermediate transfer belt 16 to run. The intermediate transfer belt 16 is disposed about a plurality of rollers. The upper half of the intermediate transfer belt 16 is sandwiched between the photoconductive drums D of the respective drum cartridges and the transfer rollers R of the belt driving mechanism 18. The lower portion of the intermediate transfer belt 16 is sandwiched between a transfer roller TR and a roller of the transfer section 10, a transfer point being defined between the intermediate transfer belt 16 and the roller TR. The print paper P advances through the middle path 8 and passes through the transfer section 10 during a printing operation.

Upon reception of print image data, the drum cartridges 14WU, 14K, 14Y, 14M, 14C, and 14WD form toner images of corresponding colors in accordance with print image data. As the intermediate transfer belt 16 runs, the toner images of corresponding colors are transferred one over the other in registration onto the intermediate transfer belt 16, and arrive at the transfer section 10 where the images are transferred onto the print paper P.

A fixing section 20 is located immediately downstream of the middle path 8, and includes a heat roller and a pressure roller. The heat roller and pressure roller rotate with the print paper P sandwiched between them. As the print paper P passes through a fixing point defined between the heat roller and the pressure roller, the toner images on the print paper P are fixed under heat and pressure.

The heat roller and pressure roller are rotatable to advance the print paper P into a discharge path 22. The discharge path 22 includes a plurality of rollers pairs, which rotate to advance the print paper P upward through the discharge path 22 so that the print paper P is discharged onto a stacker 24.

### {Functions of Color Printer}

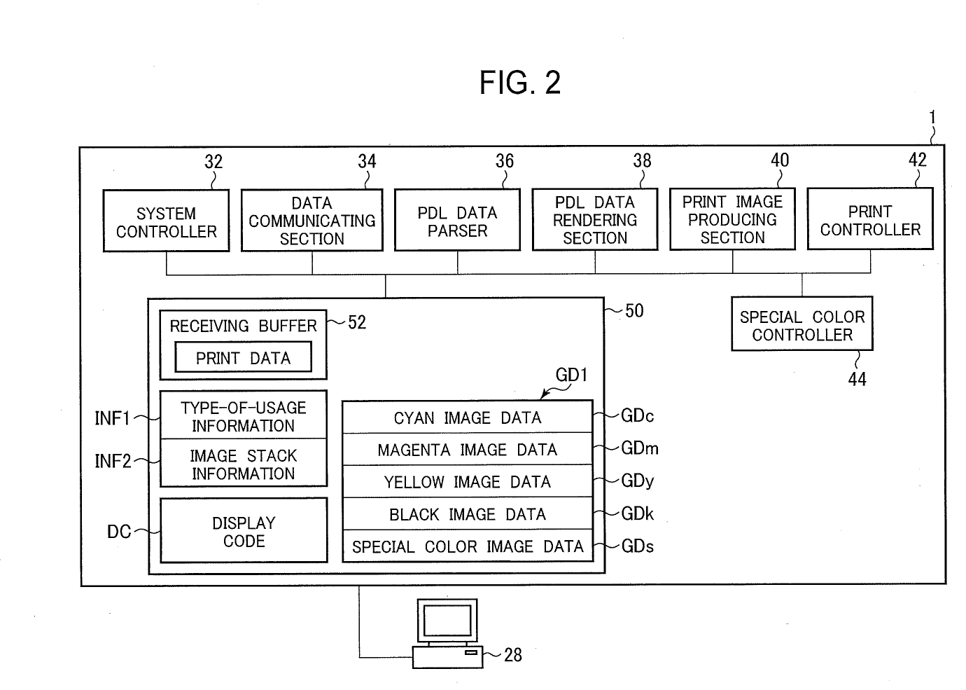

FIG. 2 is a block diagram illustrating a system controller 32 that centrally controls the color printer 1.

The system controller 32 includes central processing unit (CPU not shown), which is a main control section. The CPU reads programs from a memory (not shown) such as a read only memory (ROM), a hard disc drive, and a flash memory, thereby controlling the respective sections of the color printer 1 to perform printing.

A data communicating section 34 serves as an interface with a network or a universal serial bus (USB), and communicates via wired or wireless communications with a host apparatus 28, which is an external information terminal, for example, a personal computer. The data communicating section 34 receives print data, which describes an image to be printed, from the host apparatus 28. Upon a print command, the data communicating section 34 stores the received print data into a buffer 52.

A PDL data parser 36 reads the print data from the buffer 52, and parses commands in the print data described in a page description language (PDL). A PDL data rendering section 38 converts the print data into data described in an intermediate language, called display codes. The display code describes images including characters and graphics, objects to be printed, and the position information of the images on the print paper P. The PDL data rendering section 38 then stores the display codes into a memory 50.

A print image producing section 40 reads display codes DC from the memory 50, and produces print image data of corresponding colors for one page of the print paper. In accordance with the stack order of images specified by the print data, a special color controller 44 selects the drum cartridge 14WU and/or the drum cartridge 14WD to which special color image data should be sent.

A print controller 42 selects the drum cartridges 14K, 14Y, 14M, 14C, and the drum cartridges 14WU and/or 14WD to which print image data should be sent. In the specification, the term image data covers color image data and the special color (e.g., white) image data, and the term color image data covers image data for cyan, magenta, yellow, and black. The print controller 42 reads the print image data, which is raster data, of one page from the print image producing section 40. The print controller 42 then drives the drum cartridges 14K, 14Y, 14M, 14C, and one of the drum cartridges 14WU and 14WD to transfer toner images of corresponding colors onto the intermediate transfer belt 16. The print controller 42 then drives the transfer section 10 to transfer the toner images carried on the intermediate transfer belt 16 onto the print paper P, and subsequently drives the fixing section 20 to fix the toner images on the print paper P under heat and pressure.

The memory 50 is a volatile memory, which loses data when the power is off. The memory 50 includes a receiving buffer 52, which temporarily holds the print data and supplies the print data to the PDL data parser 36. The memory 50 holds type-of-usage information INF 1 about the type of usage of the special color specified by the print data, image stack information INF 2 indicative of whether the special color image is on the top of color images (Y, M, C, K) or on the bottom of the color images (Y, M, C, K), the display code DC, and image data GD1 that describes actual images of the respective colors. The image data GD1 includes cyan image data GDc, magenta image data GDm, yellow image data GDy, black image data GDk, and special color image data GDs. The cyan image data GDc, magenta image data GDm, yellow image data GDy, black image data GDk constitute color image data.

### {Configuration of Special Color Printing Setting Screen}

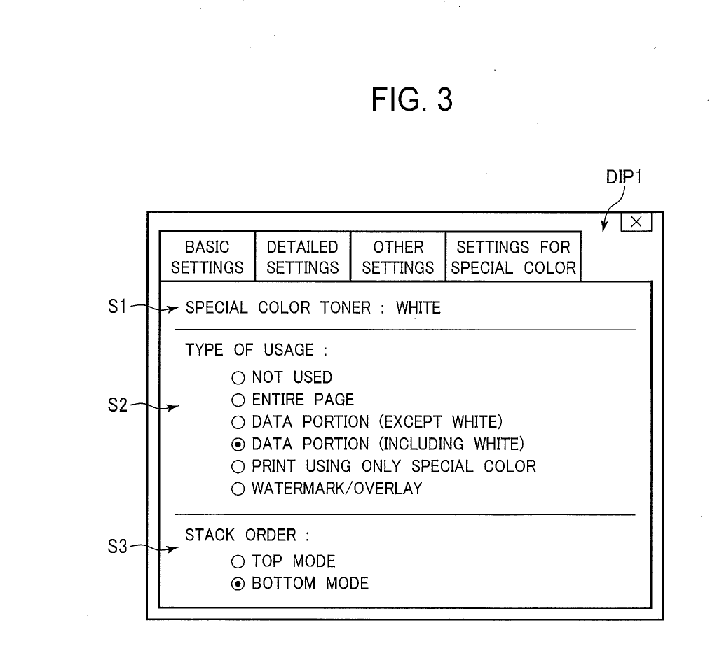

FIG. 3 illustrates a special color printing settings screen DIP1. The host apparatus 28 displays on a display device the special color printing setting screen DIP1. The screen DIP1 is a screen that prompts the user to input the necessary settings about the special color. The special color printing setting screen DIP1 includes a special color toner area S1, a type-of-usage selecting area S2, and a stack order selecting area S3. The radio buttons indicate the user's current selection.

The special color toner area S1 shows the color of toner used in the special color drum cartridge currently attached to the color printer 1. The special color toner area S1 in FIG. 3 displays “WHITE” since the special color drum cartridge according to the first embodiment uses a white toner.

The type-of-usage selecting area S2 prompts the user to select whether a special color image should be printed on top of the color images (i.e., Y, M, C, K images) or on the bottom of the color images. The type-of-usage selecting area S2 provides six candidates from which the user selects a desired one.

When “NOT USED” is selected, the color printer 1 does not use the special color, and the stack order selecting area S3 is grayed out so that the user is prohibited to make a selection of the order of stacking the special color image. When “ENTIRE PAGE” is selected, the color printer 1 prints on the entire printable area on the print paper P using the special color toner (white). When “DATA PORTION (EXCEPT WHITE)” is selected, the color printer 1 prints a special color toner layer on the color image (Y, M, C, K except white portions of the color image. When “DATA PORTION (INCLUDING WHITE)” is selected, the color printer 1 prints the color image including white portions of the color image. When “PRINT USING ONLY SPECIAL COLOR” is selected, the color printer 1 converts the non-special color image data into special color image data. When “WATERMARK/OVERLAY” is selected, the color printer 1 prints either a watermark or an overlay on a corresponding color image. For example, by making use of the light reflective property of color developer materials or a transparent developer material, overlay printing can effectively express portions of an image that are substantially the same color as the print medium.

The stack order selecting area S3 helps the user select one of a top mode and a bottom mode. The top mode is such that color images (i.e., C M, Y and K images) are printed directly on the print paper P and then a special color image is printed on top of a stack of the color images. The bottom mode is such that a special color image is printed directly on the print paper P and then color images (i.e., C M, Y, and K images) are printed on the special color image.

The color printer 1 performs printing either in the top mode or in the bottom mode.

### {Printing Operation}

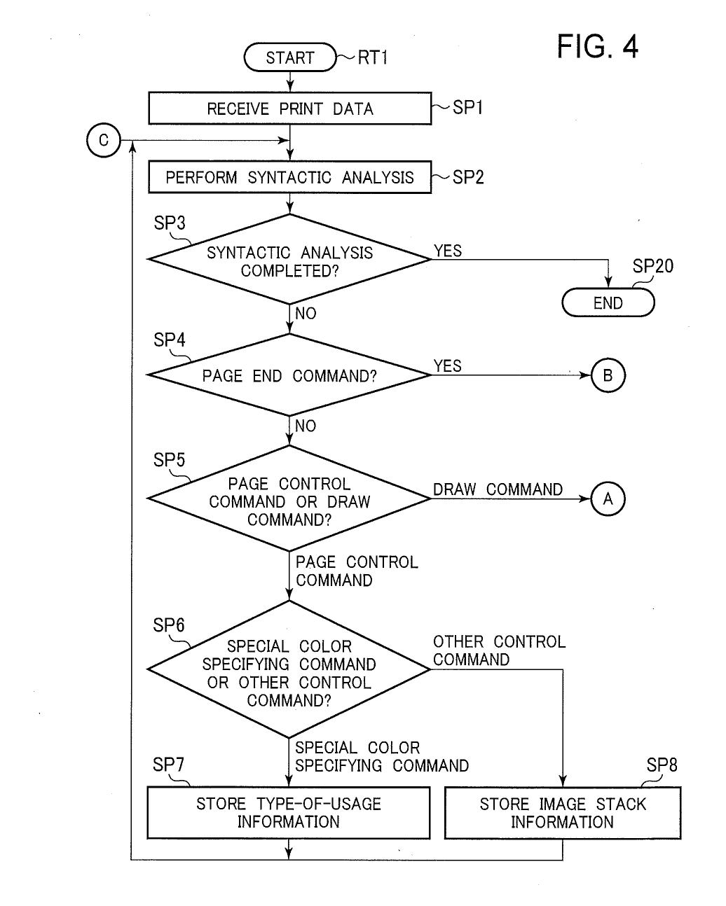

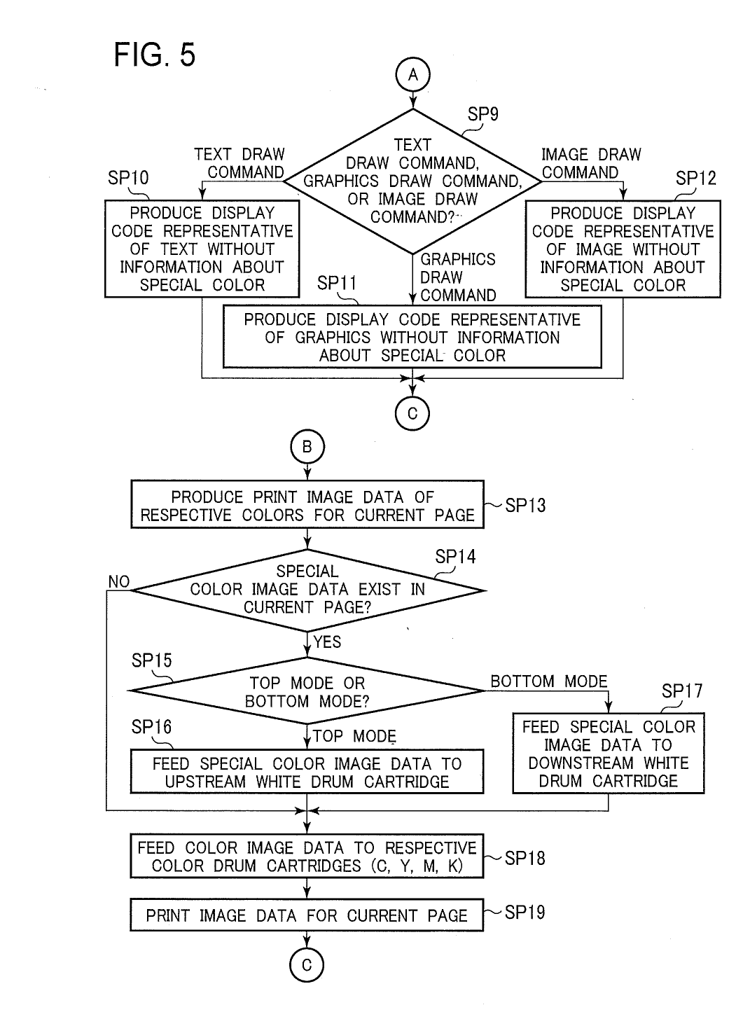

FIGS. 4 and 5 illustrate the printing procedure RT1 of the color printer 1 according to the first embodiment. The specific printing procedure will be described with reference to FIG. 4 and FIG. 5. Through the special color printing setting screen DIP1 at the host apparatus 28, the user selects the type of usage of the special color and the stack order in which images are stacked, and then commands the color printer 1 to print. Upon the print command, the system controller 32 reads a program for the printing process from the ROM, and then executes the program, thereby initiating a printing process RT1 (FIG. 4).

At step SP1, the system controller 32 receives the print data from the data communicating section 34, and stores the print data into the receiving buffer 48. At step SP2, the system controller 32 drives the PDL data parser 36 to perform the syntactic analysis of the print data on a line of an image to be printed.

At step SP3, the system controller 32 determines whether the PDL data parser 36 has completed the syntactic analysis of all of the print data. If the answer is NO, it is determined that the print data has not completely parsed yet, and therefore the system controller 32 proceeds to step SP4.

At step SP4, the system controller 32 determines whether the PDL data parser 36 has detected a page end command. If the answer is NO, it is determined that some commands in the page that is currently being parsed remain unparsed, and therefore the system controller 32 proceeds to step SP5.

At step SP5, the system controller 32 determines whether the command parsed by the PDL data parser 36 is a page control command which is a command associated with page control or a draw command which is a command used in drawing an image. If the answer is “page control command,” then the system controller 32 proceeds to step SP6 where a check is made to determine whether the parsed command is a special color specifying command which specifies a special color or a control command other than the special color specifying command. If the answer is a special color specifying command, the system controller 32 proceeds to step SP7 where the system controller 32 drives the memory 50 to store the content of the special color specifying command as the type-of-usage information INF 1 and the image stack information INF 2. The special color specifying command specifies the type of the special color, the type of usage of the special color, and the order in which the special color image and the color images (Y, M, C, K) are stacked. The type of special color is, for example, white, gold, or silver. Special color developer materials, for example, developer materials that is transparent under non-ultraviolet light and is opaque under ultraviolet rays, and developer materials that are transparent but absorb infrared rays. Subsequently, the system controller 32 jumps back to step SP2 where the system controller 32 continues to perform the syntactic analysis of the next line.

At step SP6, if the system controller 32 determines that the command parsed by PDL data parser 36 is a control command other than the special color specifying command, the system controller 32 proceeds to step SP8 where the system controller 32 stores the content specified by the parsed command into the memory 50. The commands other than the special color specifying command contain general information such as the size of the print paper P, the type of the paper tray 4, and other information. Subsequently, the system controller 32 jumps back to step SP2 where the system controller 32 drives the PDL data parser 36 to perform the syntactic analysis of the next line.

At step SP5, if the system controller 32 determines that the command is a draw command, the system controller 32 proceeds to step SP9 (FIG. 5) where the system controller 32 determines whether the parsed command is a text draw command associated with the drawing of a text draw command, a graphics draw command associated with the drawing of graphics, or an image draw command associated with the drawing of images.

AT step SP9, if the system controller 32 determines that the parsed command is a text draw command, the system controller 32 proceeds to step SP10 where the PDL data rendering section 38 produces a display code DC representative of a text based on the content of the text draw command, and then stores the display code DC into the memory 50. The text draw command specifies, for example, the type, size, and font of characters. Subsequently, the system controller 32 jumps back to step SP2 where the system controller 32 drives the PDL data parser 36 to perform the syntactic analysis of the next line. The system controller 32 according to the first embodiment produces a display code in accordance with the text draw command, not adding the information about the special color to the display code.

At step SP9, if the system controller 32 determines that the currently parsed command is a graphics draw command, the system controller 32 proceeds to step SP11 where the PDL data rendering section 38 produces a display code DC representative of a graphic figure in accordance with the content of the graphics draw command, and then stores the display code DC into the memory 50. The graphics command specifies the coordinates of a graphic figure, for example, a circle, a triangle, a rectangle, and other figures. Subsequently, the system controller 32 jumps back to step SP2 for syntactic analysis of the next line. The system controller 32 according to the first embodiment produces a display code in accordance with the content of the graphics draw command, not adding the information about the special color to the display code.

At step SP9, if the system controller 32 determine that the parsed command is an image draw command, the system controller 32 proceeds to step SP12 where the PDL data rendering section 38 produces a display code DC representative of an image in accordance with the content of the image draw command, and then stores the display code DC into the memory 50. The image draw command specifies images, for example, photographs. The system controller 32 then jumps back to step SP2 where the PDL data parser 36 performs the syntactic analysis of the next line. The system controller 32 according to the first embodiment produces a display code DC in accordance with the image draw command, not adding the information about the special color to the display code.

When the syntactic analysis of one page of the print paper P has been completed and the PDL data parser 36 has detected a page end command at step SP4, the system controller 32 proceeds to step SP13 where the print image producing section 40 produces the print image data of the respective colors, i.e., cyan (C), magenta (M), yellow (Y), black (K) and special color (e.g., white) for the current page, and stores the produced print image data as print image data GDc (cyan), GDm (magenta), GDy (yellow), GDk (black), and GDs (special color) into the memory 50. Thus, the print image producing section 40 produces a total of five items of image data for one page of the print paper P.

At step SP14, the system controller 32 drives the special color controller 44 to determine whether the special color image data GDs is present in the image data for the current page. If the answer is YES, it means that the special color image data GDs is present in the page and the special color controller 44 needs to send the special color image data GDs to the drum cartridges 14WU and 14WD. The system controller 32 thus proceeds to step SP15.

At step SP15, the system controller 32 drives the special color controller 44 to check the image stack information INF 2 held in the memory 50 to determine whether printing should be performed in the top mode or in the bottom mode.

At step SP15, if it is determined that printing should be performed in the top mode, the system controller 32 proceeds to step SP16 where the system controller 32 drives the special color controller 44 to feed the special color image data GDs to the upstream white drum cartridge 14WU, and then proceeds to step SP18. The color printer 1 is of the intermediate transfer type and therefore the bottom most toner layer on the intermediate transfer belt 16 will be the upper most toner layer on the print paper P. In other words, in the top mode, the special color image data GDs is fed to the upstream white drum cartridge 14WU.

If it is determined at step SP15 that printing should be performed in the bottom mode, the system controller 32 proceeds to step SP17 where the special color controller 44 feeds the special color image data GDs to the downstream white drum cartridge 14WD. The color printer 1 is of the intermediate transfer type and therefore the bottommost toner layer on the intermediate transfer belt 16 will be the upper most toner layer on the print paper P. In the bottom mode, the upper most toner layer on the intermediate transfer belt 16 will be the lower most toner layer on the print paper P. In other words, in the bottom mode, the special color data GDs is fed to the downstream white drum cartridge 14WD.

If the answer is NO at step SP14, it means that the special color image data GDs is not present in the image data for the page, and therefore the special color controller 44 does not need to perform any process on the special color image data GDs. Thus, the system controller 32 jumps to step SP18.

At step SP18, the system controller 32 drives the print controller 42 to feed the cyan (C), magenta (M), yellow (Y), and black (K) image data GDc, GDm, GDy, and GDk to the cyan, magenta, yellow, and black drum cartridges 14C, 14M, 14Y, and 14K, respectively. The system controller 32 then proceeds to step SP19.

At step SP19, the system controller 32 drives the print controller 42 to print the print image data for the page. Specifically, the print controller 42 drives the drum cartridges 14K, 14Y, 14M, 14C, and one of 14WU and 14WD, thereby printing images of the respective colors on the print paper P. Subsequently, the system controller 32 jumps back to step SP2 where the PDL data parser 36 performs the syntactic analysis of the next page.

Upon completion of syntactic analysis of all of the commands in the print data, the analysis of the received print data completes. Thus, the answer at step SP3 is YES, and the system controller 32 then proceeds to step SP20 where the printing procedure completes.

### {Operation and Effects}

The color printer 1 employs the drum cartridges 14K, 14Y, 14M, 14C aligned parallel to the direction in which the print paper P is transported, and the drum cartridge 14WU disposed at the upstream end with respect to the direction and the drum cartridge 14WD disposed at the downstream end with respect to the direction in which the intermediate transfer belt runs. The drum cartridges 14WU and 14WD are special color drum cartridges that print special color images (i.e., white images).

The drum cartridges 14K, 14Y, 14M, 14C, and 14WU are used in the top mode while the drum cartridges 14K, 14Y, 14M, 14C, and 14WD are used in the bottom mode.

Conventional color printers suffer from a problem in that the print paper needs to be fed in two passes, i.e., twice, through the drum cartridges, and therefore misalignment may be caused between the toner images printed in the first pass and the toner images printed in the second pass, resulting in poor print quality. Misalignment may be caused in the advance direction in which the print paper P is transported and in the scan direction perpendicular to the advance direction.

In the color printer 1 according to the invention, the print paper P is fed either through the respective drum cartridges 14K, 14Y, 14M, 14C, and 14WU or through the respective drum cartridges 14K, 14Y, 14M, 14C, and 14WD. In other words, the print paper P is fed in a single pass through the respective drum cartridges. In this manner, misalignment between the toner images can be avoided.

Some conventional color printers are configured to first form a special color (e.g., white) image on the print paper, and then fix the special color image on the print paper under heat and pressure. The print paper shrinks when the image thereon is fixed under heat and pressure. The print paper is then fed through the drum cartridges again to form images of the respective colors on the special color image. A problem with such a conventional printer is that the size of the special color image printed in the first pass becomes somewhat smaller due to shrinkage of the print paper but the size of images of the respective colors do not shrink.

In contrast, the color printer 1 according to the first embodiment is configured to transfer the images of the respective colors and special color (e.g., white) in a single pass of the intermediate transfer belt 16 either through the respective drum cartridges 14K, 14Y, 14M, 14C, and 14WU or through the respective drum cartridges 14K, 14Y, 14M, 14C, and 14WD. Thus, the print paper P passes through the transfer section 10 only once, and then advances to the fixing section 20. In this manner, the color printer 1 according to the first embodiment sufficiently eliminates misalignment of images on the print paper P, improving print quality.

This way of printing is effective not only in simplex printing but also in duplex printing.

### Second Embodiment

A second embodiment differs from the first embodiment in that printing is performed in a direct transfer mode.

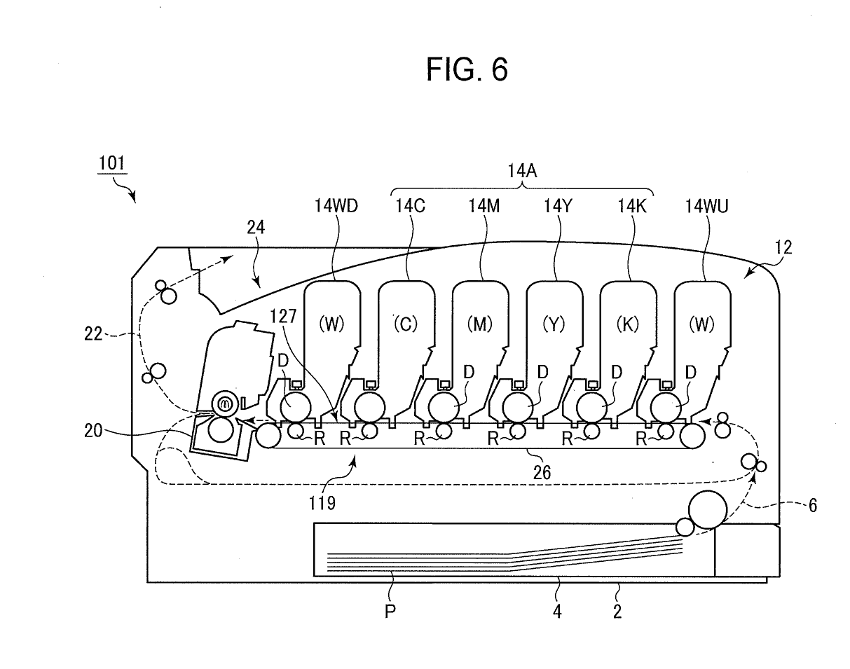

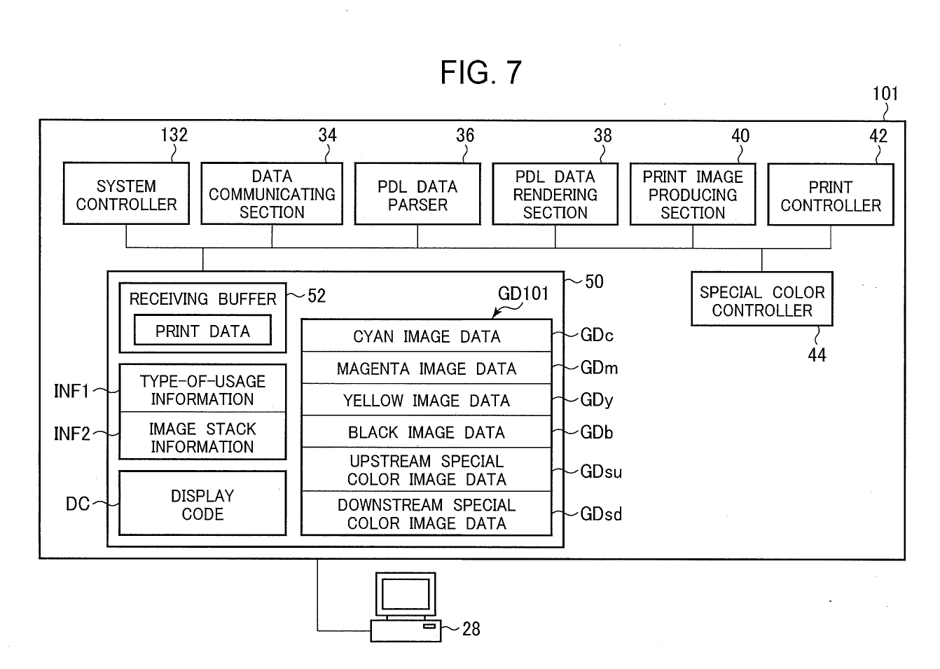

FIG. 6 illustrate a color printer 101 according to a second embodiment. The color printer 101 is of direct transfer type, and differs from the color printer 1 according to the first embodiment in that a transfer section 119 and a system controller 132 (FIG. 7) are employed.

The transfer section 119 includes a transport belt or transfer belt 26. The transfer belt 26 is an endless belt, and is disposed about a plurality of rollers under an image forming section 12. The upper half of the transfer belt 26 is sandwiched between the photoconductive drum D and transfer roller R of each of drum cartridges 14WU, 14K, 14Y, 14M, 14C and 14WD.

The drum cartridges 14WU, 14K, 14Y, 14M, 14C and 14WD form toner images in accordance with print image data. When the transfer belt 26 runs through the drum cartridges 14WU, 14K, 14Y, 14M, and 14C or the drum cartridges 14K, 14Y, 14M, and 14C, and 14WD with the print paper P thereon, toner images of the respective colors are transferred onto the print paper P at transfer points defined between photoconductive drums and the transfer belt 26. FIG. 7 is a block diagram illustrating the functions of color printer 101.

Referring to FIG. 7, a memory 50 holds the image data GD101. The image data GD101 differs from the image data GD1 of the first embodiment in that upstream special color image data GDsu and downstream special color image data GDsd are employed. The remaining portions of FIG. 7 are the same as those of the first embodiment and description thereof is omitted.

### {Configuration of Special Color Printing Setting Screen}

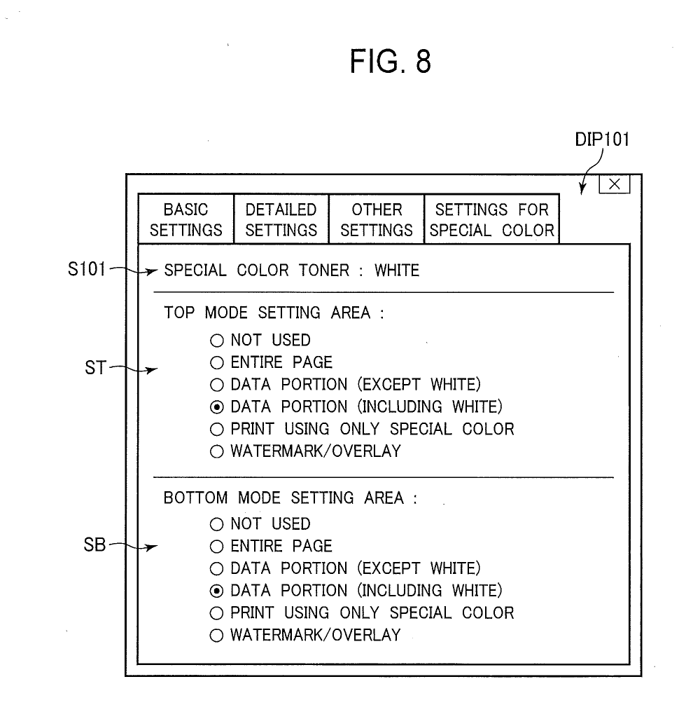

FIG. 8 illustrates a special color printing settings screen DIP101.

A host apparatus 28 displays a special color printing setting screen DIP101 on a display device. The special color printing setting screen DIP101 includes a special toner area S101, a top mode setting area ST, and a bottom mode setting area SB.

The special toner area S101 shows the color of toner used in the special color drum cartridge currently attached to the color printer 1. The top mode setting area ST prompts the user to select the types of usage and areas on the print paper P when printing is performed in the top mode. The top mode setting area ST includes six candidates from which the user selects a desired one. The bottom mode setting area SB prompts the user to select the types of usage and areas on the print paper P when printing is performed in the bottom mode.

As described above, the color printer 101 is capable of printing the special color (e.g., white) toner layer on a stack of cyan, magenta, yellow, and black image toner layers formed on a page of print paper P and/or under the stack of cyan, magenta, yellow, and black image toner layers.

### {Printing Operation}

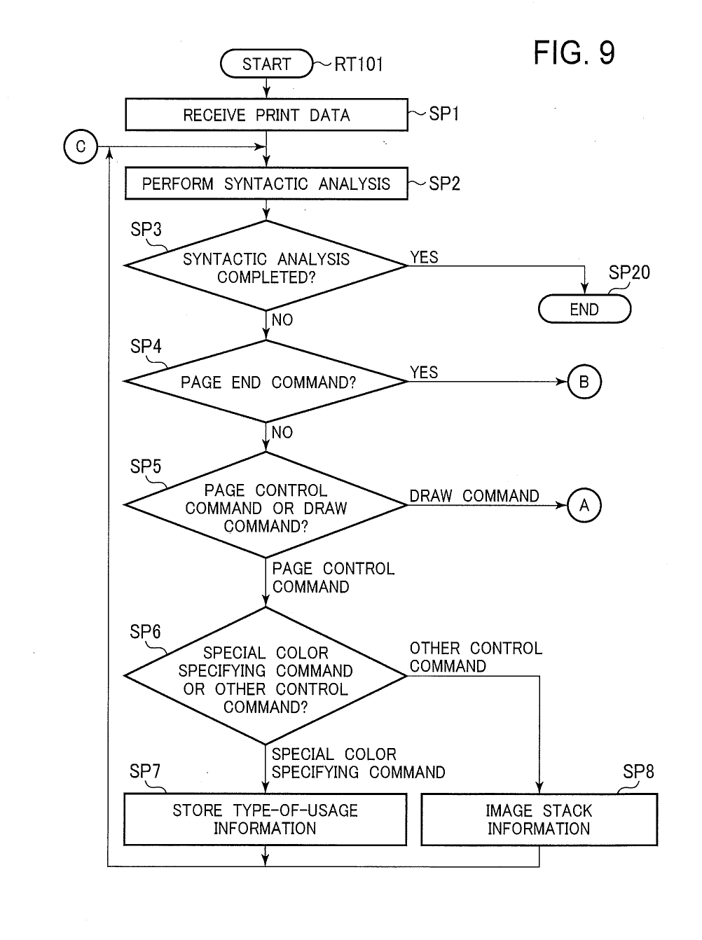

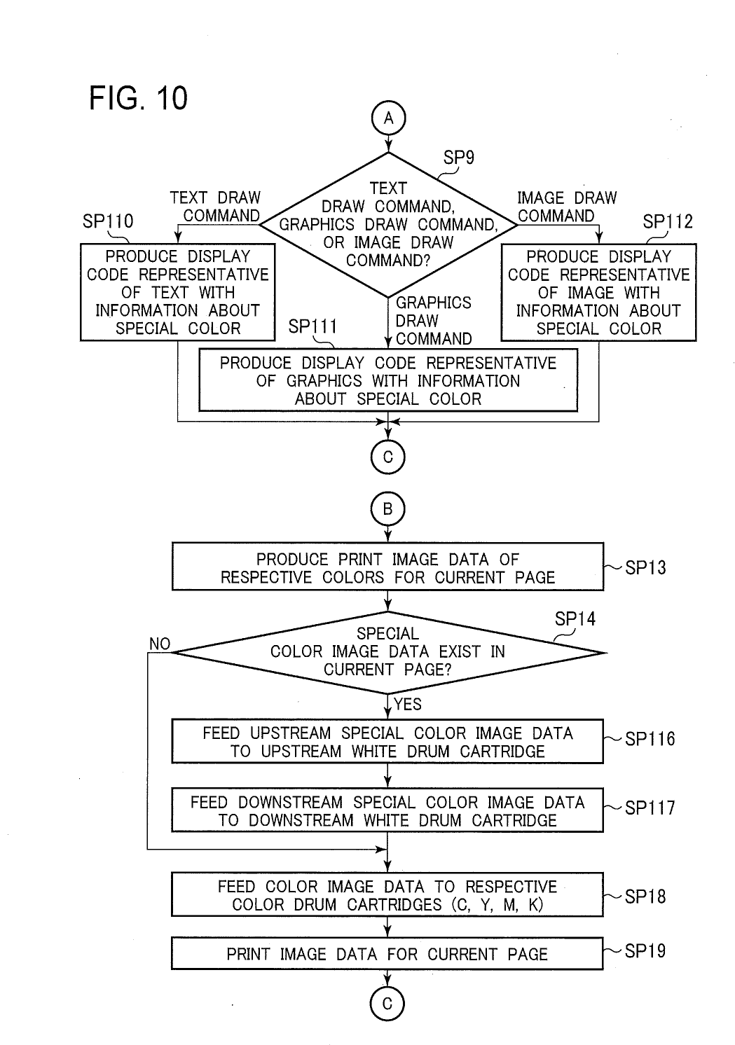

A printing procedure of the color printer 1 will be described with reference to the flowchart illustrated in FIGS. 9 and 10.

FIGS. 9 and 10 illustrate the printing procedure RT101 of the color printer according to the second embodiment. Steps SP110-SP112 differ from steps SP10-SP12. Step SP113 differs from step SP13. Steps SP116-SP117 differ from steps SP15-SP17.

At step SP1, the system controller 132 receives the print data from a data communicating section 34, and stores the print data into a receiving buffer 48. At step SP2, the system controller 132 drives a PDL data parser 36 to perform the syntactic analysis of the print data on a line of an image to be printed.

At step SP3, the system controller 132 determines whether the PDL data parser 36 has completed the syntactic analysis of all of the print data of a page. If the answer is NO, it is determined that the print data has not completely parsed yet, and therefore the system controller 132 proceeds to step SP4.

At step SP4, the system controller 132 determines whether the PDL data parser 36 has detected a page end command. If the answer is NO, it is determined that some commands in the page that is currently being parsed remain unparsed, and therefore the system controller 132 proceeds to step SP5.

At step SP5, the system controller 132 determines whether the command parsed by the PDL data parser 36 is a page control command which is a command associated with page control or an image forming command which is a command associated with image formation. If the answer is “page control command,” then the system controller 132 proceeds to step SP6 where a check is made to determine whether the parsed command is a special color specifying command which specifies a special color or a control command other than the special color specifying command. If the answer is a special color specifying command, the system controller 132 proceeds to step SP7 where the system controller 132 drives the memory 50 to store the content of the special color specifying command as the type-of-usage information INF 1 and the image stack information INF 2. The special color specifying command specifies the type of the special color, the type of usage of the special color, and the stack order in which the special color image and the color images (Y, M, C, K) are stacked. Subsequently, the system controller 132 jumps back to step SP2 where the system controller 132 continues to perform syntactic analysis of the print data.

At step SP6, if the system controller 132 determines that the command parsed by PDL data parser 36 is a control command other than the special color specifying command, the system controller 132 proceeds to step SP8 where the system controller 132 stores the content specified by the command into the memory 50. The commands other than the special color specifying command contain general information, for example, the size of the print paper P, the type of the paper tray 4 and other information. Subsequently, the system controller 132 jumps back to step SP2 where the system controller 132 drives the PDL data parser 36 to perform the syntactic analysis of the next line.

At step SP5, if the system controller 132 determines that the command is a draw command, the system controller 132 proceeds to step SP9 where the system controller 132 determines whether the currently parsed command is a text draw command associated with text draw, a graphics draw command associated with the drawing of graphics, or an image draw command associated with the drawing of images. At step SP9, a check is made to determine whether the command is an image draw command, a text draw command, or a graphic draw command.

AT step SP9, if the system controller 132 determines that the parsed command is a text draw command, the system controller 132 proceeds to step SP110, where the PDL data rendering section 38 produces a display code DC representative of a text based on the content of the text draw command and stores the display code DC into the memory 50. The text draw command specifies, for example, the type, size, and font of characters. Subsequently, the system controller 132 jumps back to step SP2 where the system controller 132 drives the PDL data parser 36 to perform the syntactic analysis of the next line. The system controller 132 according to the second embodiment produces a display code in accordance with the text draw command, adding the information about the special color to the display code.

At step SP9, if the system controller 132 determines that the currently parsed command is a graphics draw command, the system controller 132 proceeds to step SP111 where the PDL data rendering section 38 produces a display code DC representative of a graphic figure in accordance with the content of a graphics draw command, and then stores the display code DC into the memory 50. The graphics command specifies the coordinates of graphics, for example, a circle, a triangle, and a rectangle. Subsequently, the system controller 132 jumps back to step SP2 for the syntactic analysis of the next line. The system controller 132 according to the second embodiment produces a display code in accordance with the content of the graphics draw command, adding the information about the special color to the display code DC.

At step SP9, if the system controller 132 determine that the currently parsed command is an image draw command, the system controller 132 proceeds to step SP112 where the PDL data rendering section 38 produces a display code DC representative of an image in accordance with the content of the image draw command, and then stores the display code DC into the memory 50. The system controller 132 then jumps back to step SP2 where the PDL data parser 36 performs the syntactic analysis of the next line. The system controller 132 according to the second embodiment produces a display code DC that contains the information about the special color.

When the syntactic analysis of one page of the print paper P has been completed and the PDL data parser 36 has detected a page end command at step SP4, the system controller 132 proceeds to step SP113 where the print image producing section 40 produces the print image data for one page of the respective colors, i.e., cyan (C), magenta (M), yellow (Y), black (K) and special color (e.g., white), and stores the thus produced print image data as print image data GDc (cyan), GDm (magenta), GDy (yellow), GDk (black), and GDsu and/or GDsd (special color, i.e., white) into the memory 50. Thus, the print image producing section 40 produces a maximum of six items of image data for one page of the print paper P.

At step SP14, the system controller 132 drives the special color controller 44 to determine whether the special color image data GDus and/or GDds is present in the image data for the page. If the answer is YES, it means that the special color image data GDus and/or GDds is present and the special color controller 44 needs to process the special color image data GDus and/or GDds.

At step SP14, if it is determined that special color image data GDus and/or GDds is present in the image for the page of print paper P, the system controller 132 proceeds to step SP116 where the system controller 132 drives the special color controller 44 to feed the special color image data GDsu to the upstream white drum cartridge 14WU, and then proceeds to step SP117. At step SP117, the system controller 132 drives the special color controller 44 to feed the special color image data GDsd to the downstream white drum cartridge 14WD, and then proceeds to step SP118.

If the answer is NO at step SP14, it means that the special color image data GDus and/or GDds is not present in the image data for the page, and therefore the special color controller 44 does not need to perform any process on the special color image data GDus and/or GDds. Thus, the system controller 132 jumps to step SP18.

At step SP18, the system controller 132 drives the print controller 42 to feed the cyan (C), magenta (M), yellow (Y), and black (K) image data GDc, GDm, GDy, and GDk to the cyan, magenta, yellow, and black drum cartridges 14C, 14M, 14Y, and 14K, respectively. The system controller 132 then proceeds to step SP19.

At step SP19, the system controller 132 drives the print controller 42 to print the print image data for the page on the print paper P. Specifically, the print controller 42 drives the drum cartridges 14K, 14Y, 14M, 14C, and one of 14WU and 14WD, thereby printing images of the respective colors on the print paper P. Subsequently, the system controller 132 jumps back to step SP2 where the PDL data parser 36 performs the syntactic analysis of the next page.

Upon completion of the syntactic analysis of all of the commands in the print data, the analysis of the received print data completes. Thus, the answer at step SP3 is YES, and the system controller 132 then proceeds to step SP20 where the printing procedure completes.

### {Operation and Effects}

In the color printer 101, the PDL data rendering section 38 produces the display code of a text draw command, a graphics draw command, and an image draw command, the display code containing information about the special color.

Thus, in a single pass, the color printer 101 is capable of placing a toner layer of a special color (e.g., white) on the top of a stack of cyan, magenta, yellow, and black toner layers and/or on the bottom of the stack of cyan, magenta, yellow, and black toner layers. Further, a solid white toner layer may be printed on the bottom of a stack of the cyan, magenta, yellow, and black toner layers, and a water mark may be printed using a white toner on the top of the stack.

The color printer 101 is also capable of operating in the same way as the color printer 1 according to the first embodiment, and provides the same effects.

### Modifications to First and Second Embodiments

The first and second embodiments employ a white toner as a special color toner. Instead, a clear toner, which produces a transparent image, may be used as a special color toner.

The first and second embodiments have been described in terms of a white drum cartridge disposed at an upstream end and a downstream end of a line of the drum cartridges 14K, 14Y, 14M, and 14C with respect to the direction in which the transfer belt or intermediate transfer belt runs. Alternatively, two or more white drum cartridges may be disposed at the upstream end and at the downstream end, respectively. Still alternatively, a set of a white toner drum cartridge and a clear toner drum cartridge may be disposed at the upstream end and the downstream end, respectively.

Sometimes, one of the drum cartridge 14WU and the drum cartridge 14WD may be nearly exhausted of the special color toner (e.g., white). When the drum cartridge 14WU is nearly exhausted and the drum cartridge 14WD holds a sufficient amount of toner, areas of a special color image which are to be formed directly on the medium and face the areas in which portions of the color image are absent, may be printed by the drum cartridge 14WD. Likewise, when the drum cartridge 14WD is nearly exhausted and the drum cartridge 14WU holds a sufficient amount of toner, areas of a special color image which are to be formed on the color image and face the areas in which portions of the color image are absent, may be printed by the drum cartridge 14WD.

The color toners used in the first and second embodiments are cyan (C), magenta (M), yellow (Y), and black (K) toners. Alternatively, the color toners may be at least one of cyan (C), magenta (M), yellow (Y), and black (K) toners.

The present invention is not limited to the first embodiment, second embodiment, and their modifications. The invention also covers a combination of portions of the first and second embodiments and modifications. For example, the color printer 1 (FIG. 1) according to the first embodiment may be configured to perform the print procedure illustrated in FIG. 9, and the color printer 101 (FIG. 6) according to the second embodiment may be configured to perform the print procedure illustrated in FIG. 4.

The first and second embodiments have been described with respect to the electrophotographic color printers 1 and 101. The invention is not limited to these printers and may be applied to a variety of apparatus including copying machines, facsimile machines, and other apparatus configured to print images based on print data received from an external apparatus or image data received from a scanner. While the first and second embodiments have been described with respect to color images formed of color developer materials of YMCK model, the present invention may also be applied to color images formed of color developer materials of RGB model.

The printers according to the first and second embodiments have been described as employing the drum cartridges 14C, 14M, 14Y, and 14K, the downstream white drum cartridge 14WU, and the downstream white drum cartridge 14WD. The present invention is not limited to this configuration. For example, the printer of the present invention may be constituted of color image forming sections, an upstream special color image forming section, and a downstream special color image forming section, which are of various configurations. The present invention may be applied to a variety of types of electronic equipment, for example, a facsimile, a copying machine, a printer, and a computer that sends print data to the printer.

1. An image forming apparatus, comprising:
at least one first print engine configured to form a first image of a first developer material selected from a group of developer materials that are each of a primary color or black of a color model;
a medium on which the at least one first print engine prints the first image;
a second print engine disposed upstream of the at least one first print engine, the second print engine forming a second image of a second developer material, which is of a first color other than the primary colors and black;
a third print engine disposed downstream of the at least one first print engine, the third print engine forming a third image of a third developer material, which is of a second color other than the primary colors and black; and
a controller, including a central processing unit (CPU), configured to selectively drive the at least one first print engine, the second print engine, and the third print engine, the controller being configured to
obtain type-of-usage information indicative of a type of usage of the second or third developer material, and image stack information indicative of whether or not the second or third image is formed on the bottom or top of the first image,
determine whether or not the second or third print engine is driven based on the obtained type-of-usage information and the obtained image stack information, and
drive the second or third engine based on a result of the determination, so as to form the second or third image based on the type-of-usage information.

2. The image forming apparatus according to claim 1 further comprising a fixing section that fixes the first image, the second image, and the third image.

3. (canceled)

4. The image forming apparatus according to claim 1, wherein the controller drives only the at least one first print engine and the third print engine, the first image and the third image being formed in a single pass of the medium through the first and third print engines.

5. The image forming apparatus according to claim 1, wherein the controller drives only the at least one first print engine and the second print engine, the first image and the second image being formed in a single pass of the medium through the first and second print engines.

6. The image forming apparatus according to claim 1, wherein each of the second developer material and the third developer material is a transparent developer material.

7. The image forming apparatus according to claim 1, wherein the controller drives all of the at least one first print engine, the second print engine, and the third print engine.

8. The image forming apparatus according to claim 1 further comprising:
a fourth print engine disposed upstream of the second print engine;
a fifth print engine disposed downstream of the second print engine;
wherein the fourth print engine forms a fourth image and the fifth print engine forms a fifth image, the fourth and fifth images being formed of a fourth developer material different from the primary colors, black, second, and third developer materials.

9. The image forming apparatus according to claim 1, wherein the medium is an intermediate transfer belt.

10. The image forming apparatus according to claim 1, wherein the medium is a print medium carried on a transfer belt.

11. The image forming apparatus according to claim 1, wherein the second developer material and the third developer material are of a white color.

12. The image forming apparatus according to claim 1, wherein
the at least one first print engine forms the first image on the second image,
the second print engine forms the second image directly on the medium, and
the third print engine forms the third image on the first image,
the first image, the second image and the third image being formed in a single pass of the medium through the first, second, and third print engines.

13. The image forming apparatus according to claim 1 further comprising a transfer section, wherein
the image forming apparatus is of an intermediate transfer type,
the medium is an intermediate transfer belt, and
the transfer section transfers the first image, second image, and third image carried on the intermediate transfer belt onto a print medium.

14. The image forming apparatus according to claim 1, wherein
the image forming apparatus is of a direct transfer type,
the medium is a print medium carried on a transfer belt so that the first image, second image, and third image are directly transferred onto the print medium.

15. The image forming apparatus according to claim 1, wherein upon determining that the type-of-usage information indicates that only the second or third developer material is used, the controller converts the first image into the second or third image based on the image stack information.

16. The image forming apparatus according to claim 1, wherein upon determining that the type-of-usage information indicates that a watermark or an overlay is formed by the second or third developer material, the controller forms an image of the watermark or the overlay by the second or third developer material based on the image stack information.
